(19) United States
(12) Patent Application Publication
(10) Pub. No.: US 2014/0085684 A1
(43) Pub. Date: Mar. 27, 2014

(54) Inclusive Postal Service

(71) Applicant: Raanan Liebermann, North Haven, CT (US)

(72) Inventor: Raanan Liebermann, North Haven, CT (US)

(21) Appl. No.: 13/624,914

(22) Filed: Sep. 22, 2012

(51) Int. Cl. H04N 1/00

(52) U.S. Cl. CPC H04N 1/00209
USPC 358/402

(57) ABSTRACT

A service, system and method for an improved postal service that is inclusive of various needs of customers, utilizing electronic mail and hardcopy mail sending and delivering with economy to the postal service and advancing its operation to be suitable for modern times.

### CROSS REFERENCE TO RELATED APPLICATION(S)

This application claims the benefit of U.S. provisional patent application No. 61/626,168 filed Sep. 22, 2011, entitled “INCLUSIVE POSTAL SERVICE”, that is incorporated herein by reference in its entirety.

### FIELD OF THE INVENTION

The present invention relates to an improved method and system for the postal service in face of declining volume, increased expenses and increasing competitive forces. Said competition is from such entities as delivery companies, such as UPS, or FedEx, as well as the increasing public usage of electronic mail delivery. Said electronic mail delivery benefits from traditional Internet email, as well as new formats, such as mobile communication devices and social networks. The present invention further aims at utilizing said new technologies for the benefit of providing postal service to close and remote locations from postal hubs, as well as enabling electronic stamp facilities on an equal basis for all.

Transitioning to a complete electronic mail in the U.S. Postal Service may present a problem of discrimination against people who do not utilize the Internet, mobile communication or social networking, because of one reason or another, being for example age related or way of life and belief system. Therefore, the present invention enables an intermediary transition, providing service inclusively to all segments of users, and which may in time evolve to an even more comprehensive and fiscally sound service.

### SUMMARY OF THE INVENTION

The method and system provided herein enables migrating to electronic mail delivery for those who can benefit from it, while at the same time allowing hard copy mail to be delivered to segments of the population that by either preference, need or both, would require hardcopy mail delivery and sending. Said system would prove to be more economical than the currently used system that is exclusively hard copy, while allowing for all segments of the population to send and receive mail in a form relevant to their form of life. The invention further may enable those utilizing electronic mail who need or desire to send a hardcopy mail at any time, an easy electronic stamp for the mail-piece without the need to go and purchase a hardcopy stamp, or utilize an electronic stamping machine.

Furthermore, said system would maintain confidentiality accorded personal communications, while at the same time may enable to bring into the labor force an unutilized members of the society. Namely, the option exists to forego expensive introduction of automated machinery with appropriate sensors for extraction of hardcopy mail from its envelopes, allowing blind persons to perform such functions, while safeguarding the anonymity and confidentiality of the mail content, its senders and recipients.

### BRIEF DESCRIPTION OF THE DRAWING(S)

FIG. 1 illustrates the sending process for hardcopy mail that is akin to if not identical to the current process in a typical locality

FIG. 2 illustrates the general steps for providing inclusive mail to all segments of society, whether by hardcopy or electronic form.

FIG. 3 illustrates the mechanism of differentiation between electronic destination and hardcopy receipt of mail

FIG. 4 illustrates the transformation from electronic receipt of mail to hardcopy form and its delivery.

FIG. 5 illustrates the process for an electronic facsimile stamp on a hardcopy mail-piece.

### DETAILED DESCRIPTION OF THE PREFERRED EMBODIMENT(S)

Mail in its traditional hardcopy is deposited in at least one of a personal physical mailbox and a communal mailbox serving mostly residents of a specific locality in the vicinity or proximity of said communal mailbox.

The mail is collected by a designated person that may be at least one of a mailman or mailwoman, a designated mail collector by the locality governing board, an employee of a company that collects such mail or a volunteer assigned for such mail collection.

Said collected mail is transported to a central location that is dedicated to collection and processing of mail.

Said processing of mail in said central location entails such processes as extracting the mail piece from its encasing, such as an envelop, providing it with a unique identification, such as an ID number, a barcode or a Quick Response Code (QR code), and assigning to said identification number or designation the sender's name and address, as well as the addressee name and address. Said designation of sender and recipient may be in at least one of a the form of an image taken of said envelope, a code designation, such as a barcode or QR, or at least one of a at least one ASCII character(s) and other forms available in the state of the art, and a telephone or facsimile number.

Subsequent steps may include at least one of a scanning of preferably both sides of each said extracted mail piece(s), checking whether said addressee has an electronic email address and forwarding said scanned extracted mail piece(s) to said electronic address if available. Said electronic address may be at least one of an email address, a facsimile phone number address, a mobile mail address, social networking address, a code designation of the address, such as a barcode, QR code, or any other form known in the art.

If said subsequent steps do not reveal electronic address for said addressee, said processing may entail forwarding the scanned extracted mail piece by electronic mail to a central processing location in the vicinity of said addressee.

Said receiving central processing location in vicinity of said addressee may then locate addressee's address based on at least one of the unique name and address related to said mail piece and a code received with said mail piece, such as a barcode, QR code or any form code known in the art, affix addressee's address on at least one of a the received scanned mail piece, an envelope into which said mail piece will be inserted, seal said envelop and dispatch the printed scanned mail piece to a holding area from where said mail piece will be retrieved for physically forwarding to addressee.

Said mail piece in said holding area may then be picked up by at least one of a the addressee who comes to fetch the mail piece and a designated person in same capacity of the aforementioned designated person for collecting a hardcopy mail piece, who may forward the hardcopy mail piece to the addressee's address.

Said processing mail in said central-processing locations may be performed by at least one of an automated system and employees of said processing central processing locations. Said employees may be employees with disability, and specifically sight disability where said employees cannot read the mail content even with enhancing facilitation, such as glasses.

While the funding for paying said disabled employees may be covered through at least one of Federal allocations and cost of sending and receiving mail, such as stamps, the funding for the said designated persons who collects and forwards the hard copy mail may be covered by the local municipality that in turn taxes at least one of its constituents and said sending and receiving persons who choose not to utilize electronic mail.

Further, presumably the invented system and method is in part transitional until all mail may become electronic. Meanwhile even hardcopy mail may avail itself in part to become electronic by utilizing electronic facsimile stamps purchased online and is incorporated here. Thus there may be individuals or entities desiring to utilize hardcopy mail form albeit having the ability to do so electronically and may further be interested to utilize electronic stamps for said hardcopy mail, without the need to purchase hardcopy stamps or utilize existing electronic stamping machinery. A device such as a mobile communication device may enable to perform said electronic stamping as follows. An individual or an entity may purchase ahead of use or contemporaneous with preparing a mail article to be dispatched a form of payment for said dispatch that authenticates such payment to the service provider, such as the US postal Service. Such payment may be processed from the location where said individual or entity is present by utilizing any available payment process in the art, such as the Liebermann's Fast Cash Transaction (FCT) in U.S. Pat. No. 7,287,009 and it Continuation-In-Part application Ser. No. 13/546,029 that are incorporated herein by reference. Said payment process may utilize a mobile communication device that may further impart to the mail article evidence of such appropriate payment. Such evidence may be in a form of affixing an electronic stamp wherein said electronic stamp may be at least one of a hardcopy evidence and an image caused by another device such as a mobile phone that emits a frequency affecting said envelop or the article on it to react in at least one of a physically and chemically to said frequency by producing said visible evidence.

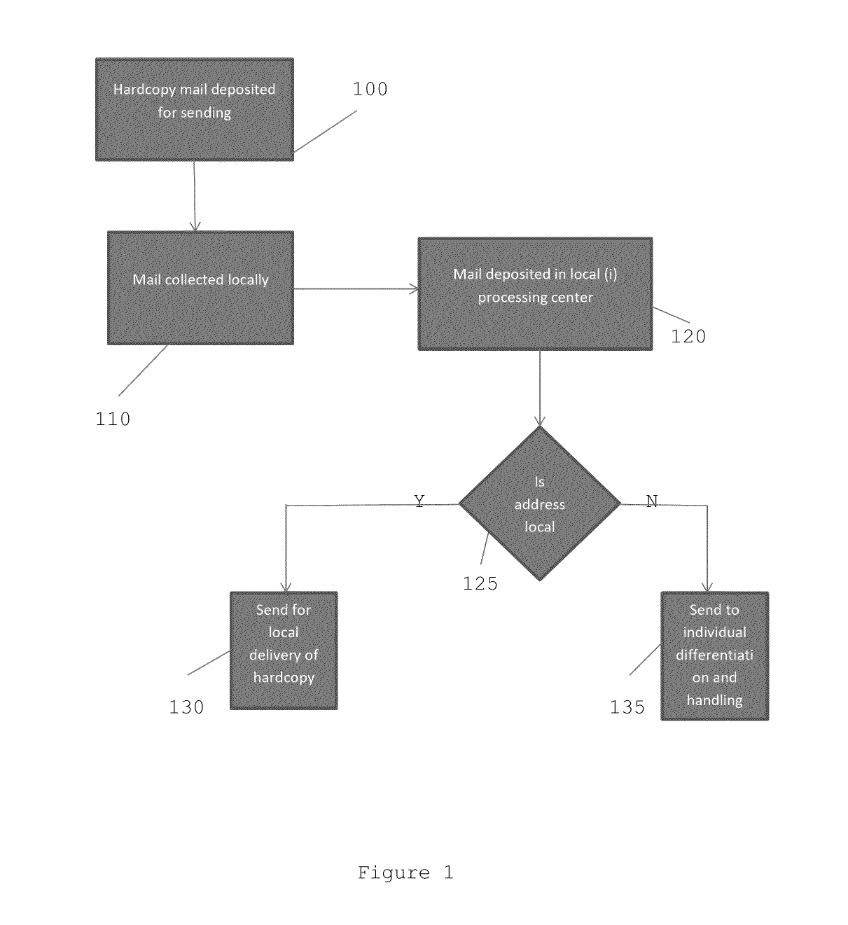

Referring now to FIG. 1, it illustrates the sending process for hardcopy mail. The hardcopy mail is deposited for sending in (100) and collected locally in (110). The mail is then deposited in (120) in a local processing center [I]. Next, it is queried in (125) if the address is local. If the answer to the query in (125) is affirmative, the mail is sent in (130) for local delivery. If the answer to the query in (125) is negative, the mail piece is sent to individual differentiation and handling in (135).

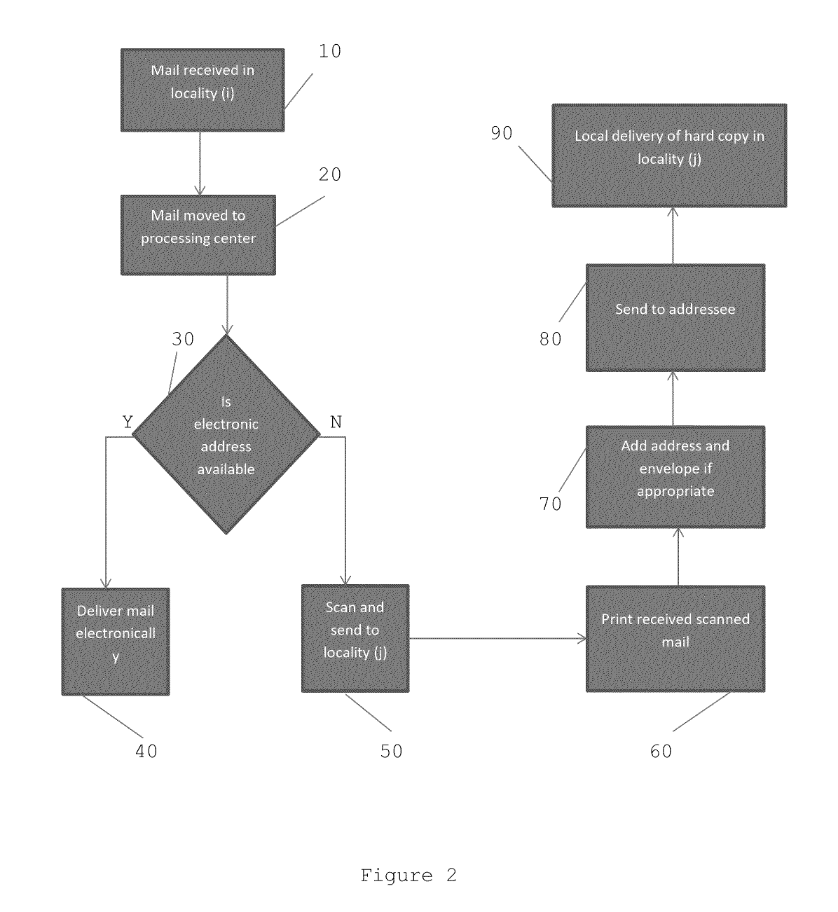

FIG. 2 illustrates the general steps for providing inclusive mail to all segments of society, whether by hardcopy or electronic form. Mail is deposited in locality [I] in (10) and is moved to processing in (20). At processing it is inquired in (30) whether an electronic address is available for the addressee. If the answer is affirmative, the mail piece is delivered electronically in (40). If the answer to the query in (30) is negative, the mail piece is scanned in (50) and sent electronically to locality [J]. The electronically received mail piece in locality [j] is printed in locality [j] in (60) and an address and envelop where appropriate are added in (70). Thereupon the mail piece is sent to addressee in (80) and a local delivery of a hard copy is delivered to the addressee in (90).

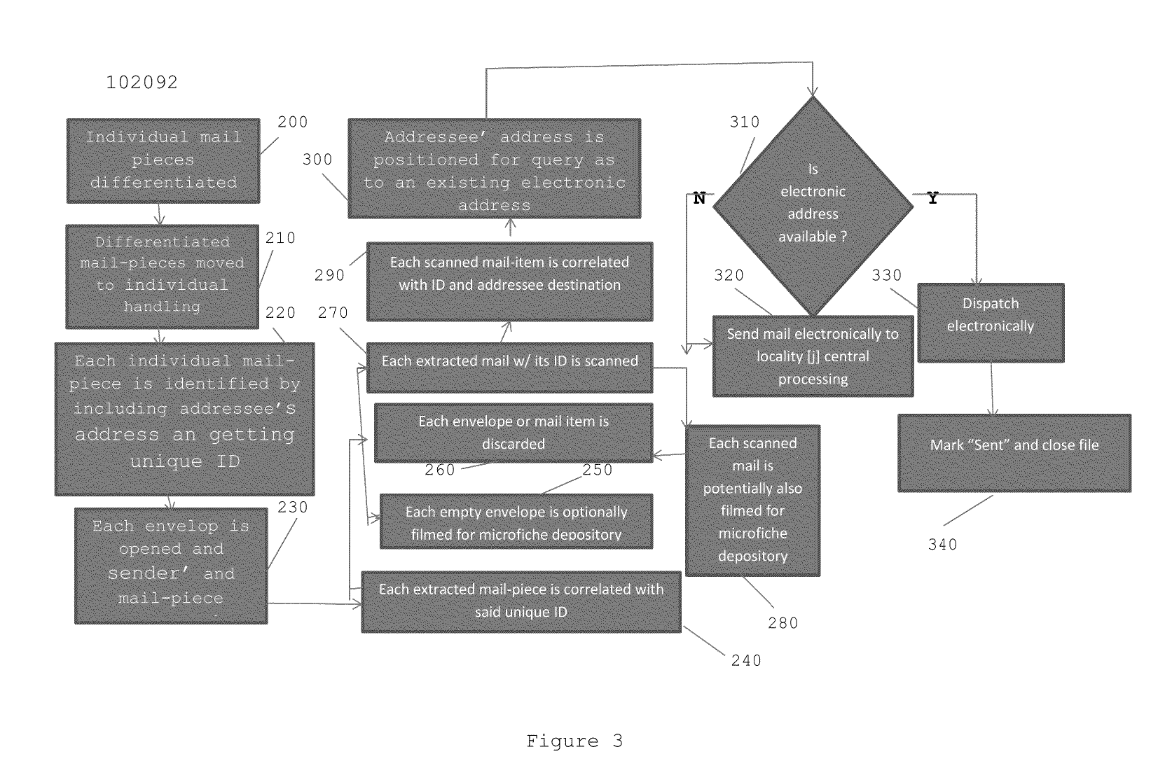

FIG. 3 illustrates the mechanism of differentiation between electronic destination and hardcopy receipt of mail, as well as processing each appropriate mail piece. An individual mail piece is differentiated in (200) and then moves in (210) into individual handling. Each individual mail piece is marked for identification by a unique ID in (220) and is identified by the sender and recipient address. Thereupon, each envelope is opened in (230) and the mail piece is extracted. The extracted mail piece receives in (240) the same specific marking that the envelope received in (220). Next, the names and addresses of the empty envelope are optionally filmed for microfiche depository in (250) and sent to be disposed off in (260). Each extracted and marked mail piece is scanned in (270) and potentially filmed for microfiche depository in (280) then sent to be disposed off in (260). Each of the scanned and marked items from (270) is correlated with proper identifying mark and the address destination in (290). Next, addressee's address is positioned to be queried for availability of an electronic address in (300). It is then queried in (310) to whether such an electronic address is available. If the answer to the query in (310) is negative, the marked scanned item is sent electronically in (320) to the processing center in locality [j] that is in the vicinity of the addressee's location. If the answer to the query in (310) is affirmative, the scanned item is dispatched electronically in (330) to the addressee's electronic address. Thereupon the case is marked as delivered in (340) and the file is closed.

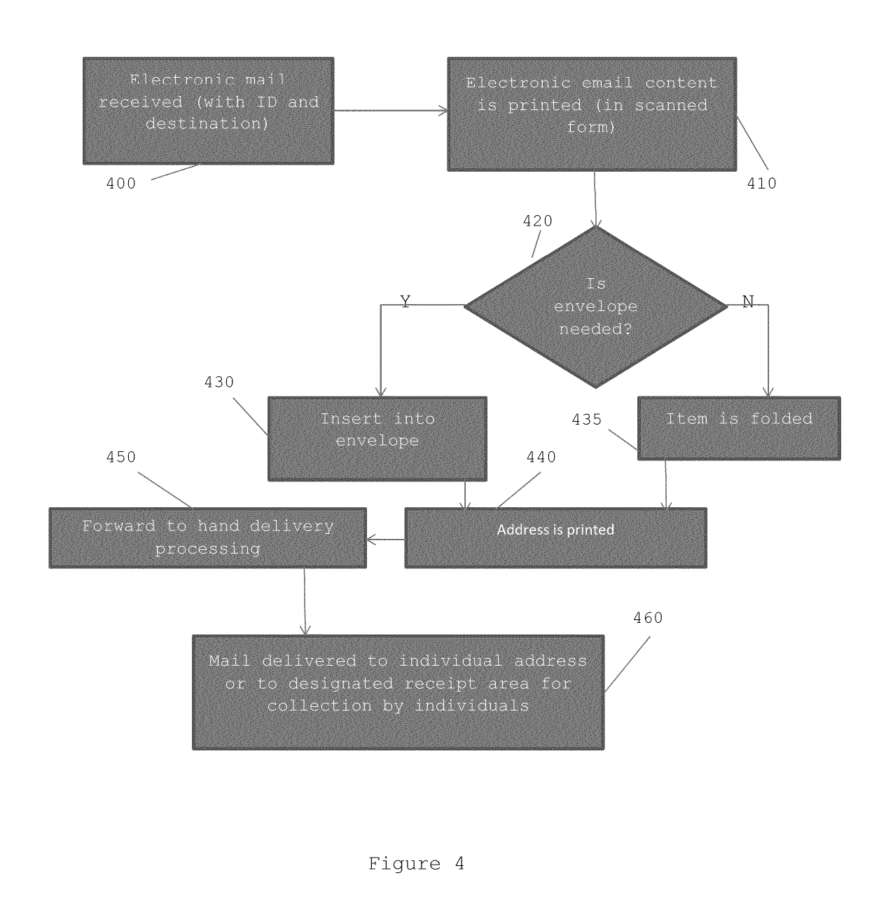

FIG. 4 illustrates the transformation from electronic receipt of mail to hardcopy form and its delivery. Electronic mail of the scanned hard copy mail is received in the processing center of locality [j] in (400) together with its marked identification and destination. The electronic scanned mail piece is printed on a hard copy in (410). Next it is queried in (420) whether an envelope is required. If the answer to the query in (420) is affirmative, the hardcopy printed mail piece is inserted into an envelope in (430) and the addressee's address is affixed to the envelope in (440). If the answer to the query in (420) is negative, the scanned mail piece may be folded in (435) and have its unprinted face positioned for address printing or other form of address affixing, which is printed or affixed on it in (440). Next, the scanned mail item with the printed addressee's address is forwarded in (450) for delivery to addressee. The scanned mail is delivered to the addressee or deposited in a designated area for the addressee to collect same in (460).

The steps marked in 230 to at least those marked in 280 and 290 can optionally be handled by sight disabled employees, such as blind employees who are trained to manually perform the marked functions while possibly side stepping automation and guaranteeing full confidentiality of the written content.

The benefits for employing said blind employees are both economic and social. On the economic level, salary for the deaf employees puts money in their pockets that will find its way for purchases, helping the economy. Socially, it will provide productive work for disabled members of society while adding purpose and pride to their lives.

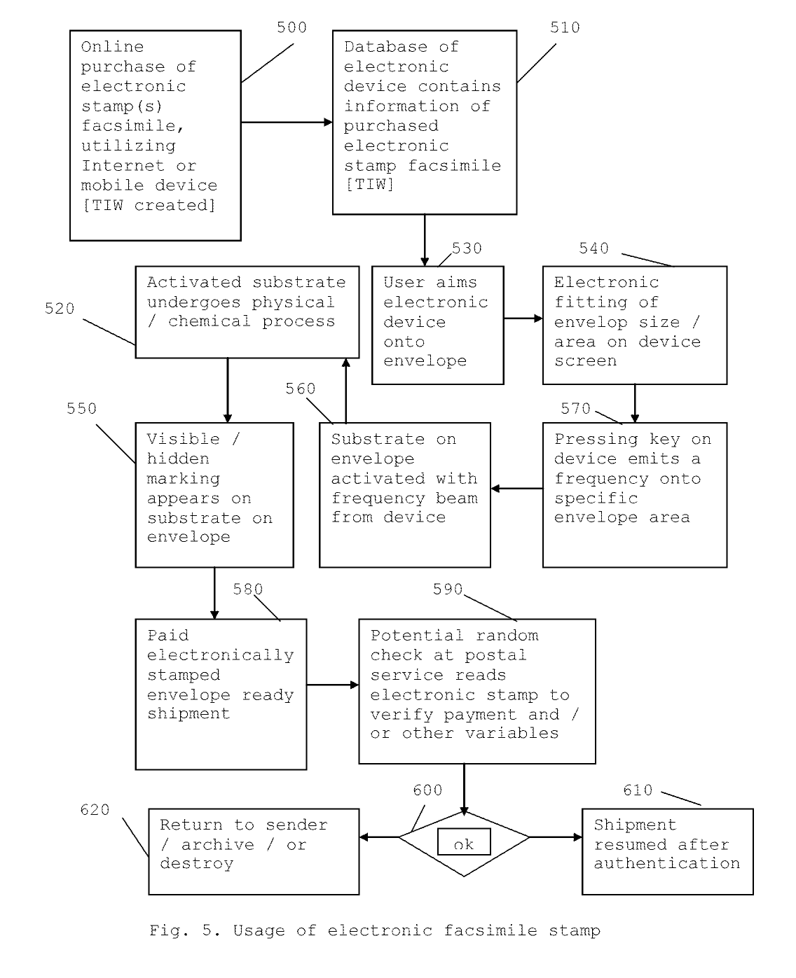

We turn now to FIG. 5 that illustrates the usage of a device, such as a mobile communication device for acquiring and affixing electronic stamp facsimile to a mail article. The user acquires the rights for usage of at least one such stamp in (500) where the user pays the postal service the appropriate amount of such stamp that is current at the time. Such payment may be done through the mobile device utilizing the FCT and receiving form it proper verification of such yet unused stamp by receiving a Transaction-In-Wait identification (TIW). Said purchase confirmation is then be logged in the device in (510). The user may then, at any point in time desired, point the device such as a mobile communication device at the article that needs shipment such as an envelope in (530). The image of the article appears in (540) on the screen of said device and its appropriate edges can be appropriately be fitted by the user moving the device as necessary. Next, the user presses or touches (in the case of a touch-screen) the appropriate key and a beam of certain frequency is transmitted in (570) form said device to said envelope hitting the envelope in the desired area where a substrate, such as a chemical substrate is affixed to the envelope or coated on it. said substrate is activated in (560) through at least one of a physical and chemical process and undergoes in (520) at least one of a physical and chemical process that cause in (550) at least one of visible markings to show on said substrate, and hidden markings that may be read with a device for verifications. Said visible and hidden markings may contain codes or other information known in the art that enable verification that indeed said markings represent a properly purchased usage from the appropriate service provider or its agent, such as the postal service. The mail article is now ready for shipment in (580). The postal service may at any time inspect in (590) the shipped article in order to verify proper payment for the service through the purchase of the electronic facsimile stamp. If the check was OK as verified in the inspection and the answer to the query if it was OK is affirmative in (600) then the shipment resumes in (610). Otherwise, if the answer in (600) is negative, the article undergoes one of several options in (620), such as returning to sender, being archived or destroyed.

As can be seen from the foregoing description, a new method and system has been described for improving postal service to the population while maintaining same level of delivery as suitable to personal needs. While the present invention has been described in the context of specific embodiments thereof, other alternatives, modifications, and variations may become apparent to those skilled in the art having read the foregoing description. Accordingly, it is intended to embrace those alternatives, modifications, and variations.

What is claimed is:

1. The method for a hardcopy piece of mail to undergo transformation to an electronic form with full privacy at a postal delivery service before delivering to recipient.

2. The method in accordance with claim 1 wherein said delivery may be one of a hardcopy and electronic delivery.

3. The method in accordance with claim 2 wherein said electronic delivery may be by at least one of a wire, fiber optics, cable, wireless, and WiFi means.

4. The method in accordance with claim 2 wherein said electronic delivery may be at least one of a delivery to an email address, an FCT Telephone Number Address, and a mobile communication device

5. The method in accordance with claim 1 wherein said transformation comprise at least one of a extraction of said mail piece from its enclosure, creating an electronic facsimile of said content, and creating an electronic facsimile of sender address and recipient address of said mail.

6. The method in accordance with claim 5 wherein said facsimile of said mail is forwarded electronically to at least one of an addressee having access to receiving said electronic forwarded mail and a postal service in another location having access to receiving said electronic forwarded mail.

7. The method in accordance with claim 6 wherein said postal service in another location creates a hardcopy facsimile of said electronic facsimile of said mail for at least one of a delivering said hardcopy facsimile mail to the addressee of said mail and making said hardcopy facsimile mail available for said addressee for collection.

8. The method in accordance with claim 2 wherein a legal tender postal facsimile stamp is affixed onto a hardcopy mail piece by at least one of electronic and chemical means.

9. The method in accordance with claim 8 wherein
at least one of a electronic device and a mobile communication device emits electronic frequency on at least one of a substrate composing an envelop and a substrate affixed to an envelope that undergoes at least one of a physical and chemical change to reflect the information transmitted electronically by said at least one of a electronic device and a mobile communication device.

10. The system for a hardcopy piece of mail to undergo transformation to an electronic form with full privacy at a postal delivery service before delivering to recipient

11. The system in accordance with claim 10 wherein said delivery may be one of a hardcopy and electronic delivery.

12. The system in accordance with claim 11 wherein said electronic delivery may be by at least one of a wire, fiber optics, cable, wireless, and WiFi means.

13. The system in accordance with claim 11 wherein
said electronic delivery may be at least one of a delivery to an email address, an FCT Telephone Number Address, and a mobile communication device.

14. The system in accordance with claim 10 wherein said transformation comprise at least one of a extraction of said mail piece from its enclosure, creating an electronic facsimile of said content, and creating an electronic facsimile of sender address and recipient address of said mail.

15. The system in accordance with claim 14 wherein said facsimile of said mail is forwarded electronically to at least one of an addressee having access to receiving said electronic forwarded mail and a postal service in another location having access to receiving said electronic forwarded mail.

16. The system in accordance with claim 15 wherein said postal service in another location creates a hardcopy facsimile of said electronic facsimile of said mail for at least one of a delivering said hardcopy facsimile mail to the addressee of said mail and making said hardcopy facsimile mail available for said addressee for collection.

17. The system for affixing a legal tender postal facsimile stamp onto a mail piece by at least one of a electronic and chemical means.

18. The system in accordance with claim 17 wherein at least one of a electronic device and a mobile communication device emits electronic frequency on at least one of a substrate composing an envelop and a substrate affixed to an envelope that undergoes at least one of a physical and chemical change to reflect the information transmitted electronically by said at least one of a electronic device and a mobile communication device.
